(19) United States
(12) Patent Application Publication
(10) Pub. No.: US 2025/0190936 A1
(43) Pub. Date: Jun. 12, 2025

(54) METHOD AND SYSTEM FOR AUTONOMOUSLY UNLOADING TAIL-ADJACENT PALLETS IN LOADING DOCKS

(71) Applicant: Fox Robotics, Austin, TX (US)

(72) Inventors: Peter Anderson-Sprecher, Austin, TX (US); Arun Joseph, Austin, TX (US); Victor Aladele, Austin, TX (US); Vaibhav Shete, Austin, TX (US)

(73) Assignee: Fox Robotics, Austin, TX (US)

(21) Appl. No.: 18/532,783

(22) Filed: Dec. 7, 2023

(51) Int. Cl. G06Q 10/087

(52) U.S. Cl. CPC G06Q 10/087

(57) ABSTRACT

A method and a system for a tail-adjacent pallet picking are disclosed. The method includes obtaining a geometry of a ramp, where the ramp operatively connects a trailer floor to a warehouse floor associated with operation of an autonomous forklift and obtaining data comprising a location of the tail-adjacent pallet and a location of pallet pockets of the tail-adjacent pallet. Further, the method includes determining, based on the geometry of the ramp and the obtained data, an inserting trajectory of forks and determining a configuration of the forks of the autonomous forklift based on the inserting trajectory. The forks of the autonomous forklift are inserted into the pallet pockets of the tail-adjacent pallet based on the determined configuration of the forks and the tail-adjacent pallet are extracted based on an extraction trajectory and associated configuration of the forks of the autonomous forklift.

### BACKGROUND

Forklifts are vehicles commonly used in industrial settings to lift and transport heavy packages. The forklifts are important for efficient storage operations as they provide easy stocking and organizing the packages in an open space or on shelves. Further, the forklifts enable optimized use of the space and improve overall productivity in a warehouse management.

Based on a presence or absence of the required human control, the forklifts may be manual and/or automated. The automated forklifts use sensors, cameras, navigation systems, and processing units to navigate around a warehouse and to transport packages autonomously. Automation of the forklifts enables a higher efficiency as the automated forklifts may operate for longer periods of time compared to the manual forklifts operated by humans.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments disclosed herein relate to a method for a tail-adjacent pallet picking. Specifically, the method includes obtaining a geometry of a ramp, where the ramp operatively connects a trailer floor to a warehouse floor associated with operation of an autonomous forklift and obtaining data comprising a location of the tail-adjacent pallet and a location of pallet pockets of the tail-adjacent pallet. Further, the method includes determining, based on the geometry of the ramp and the obtained data, an inserting trajectory of forks and determining a configuration of the forks of the autonomous forklift based on the inserting trajectory. The forks of the autonomous forklift are inserted into the pallet pockets of the tail-adjacent pallet based on the determined configuration of the forks and the tail-adjacent pallet are extracted based on the determined configuration of the forks of the autonomous forklift.

In general, in one aspect, embodiments disclosed herein relate to a method for a tail-adjacent pallet picking. Specifically, the method includes obtaining data comprising a geometry of a ramp, a location of the tail-adjacent pallet, and a location of pallet pockets of the tail-adjacent pallet, wherein the ramp operatively connects a trailer floor to a warehouse floor associated with operation of an autonomous forklift and determining, based on the plurality of sensors, a distance between forks and the ramp. Further, the method includes adjusting a configuration of the forks of the autonomous forklift and inserting the forks of the autonomous forklift into the pallet pockets of the tail-adjacent pallet, based on the determined configuration of the forks. The tail-adjacent pallet is extracted based on the determined configuration of the forks of the autonomous forklift.

In general, in one aspect, embodiments disclosed herein relate to a system including an autonomous forklift, a plurality of sensors, a ramp, and tail-adjacent pallet, wherein the autonomous forklift includes a plurality of sensors mounted on the autonomous forklift and forks configured to be inserted into pockets of a tail-adjacent pallet and the plurality of sensors are configured to obtain data comprising a geometry of a ramp, a location of the tail-adjacent pallet, and a location of pallet pockets in the tail-adjacent pallet. Further, the ramp operatively connecting a trailer floor to a warehouse floor associated with operation of the autonomous forklift and the tail-adjacent pallet are located on the trailer floor, wherein the tail-adjacent pallet is configured to be picked up and moved by the autonomous forklift using an inserting trajectory of the forks of the autonomous forklift. A configuration of the forks of the autonomous forklift to pick up the tail-adjacent pallet is based on the geometry of the ramp and the location of the tail-adjacent pallet, and the location of pallet pockets in the tail-adjacent pallet.

Other aspects and advantages will be apparent from the following description and the appended claims.

### BRIEF DESCRIPTION OF DRAWINGS

Specific embodiments of the invention will now be described in detail with reference to the accompanying figures. Like elements in the various figures are denoted by like reference numerals for consistency. Like elements may not be labeled in all figures for the sake of simplicity.

FIGS. 1A-1C show an automated forklift system, in accordance with one or more embodiments of the invention.

FIGS. 2A-2C show an architecture for two sources of control of the forklift, in accordance with one or more embodiments of the invention.

FIGS. 3A and 3B show diagrams of the tail-adjacent pallet lifting process in accordance with one or more embodiments of the invention.

FIGS. 4A-4C show flowcharts describing a process of autonomous unloading of tail-adjacent pallets, in accordance with one or more embodiments of the invention.

FIG. 5 shows a neural network in accordance with one or more embodiments of the invention.

FIG. 6 shows a flowchart in accordance with one or more embodiments of the invention.

FIG. 7 shows a diagram of the forklift driving from the floor of warehouse to the floor of trailer in accordance with one or more embodiments of the invention.

FIGS. 8A and 8B show an angle and model of the trajectory of the forks for the autonomous forklift in accordance with one or more embodiments of the invention.

FIG. 9 shows diagrams of a plurality of pallet models in accordance with one or more embodiments.

FIG. 10A shows a machine learning model's recognition of a pallet and pallet's face-side pockets, in accordance with one or more embodiments of the invention.

FIG. 10B shows a machine learning model's recognition of forks, in accordance with one or more embodiments of the invention.

FIG. 11 shows a model of the trajectory of the forks for the autonomous forklift in accordance with one or more embodiments of the invention.

FIG. 12A shows a diagram of the diagonal approach of the forklift in accordance with one or more embodiments of the invention.

FIGS. 12B and 12C show different ramp wall configurations in accordance with one or more embodiments of the invention.

FIG. 12D shows a diagram of a weather guard obstructing pallet extraction in accordance with one or more embodiments of the invention.

FIG. 13 shows a computing system in accordance with one or more embodiments of the invention.

### DETAILED DESCRIPTION

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (e.g., any noun in the application). The use of ordinal numbers does not imply or create a particular ordering of the elements or limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

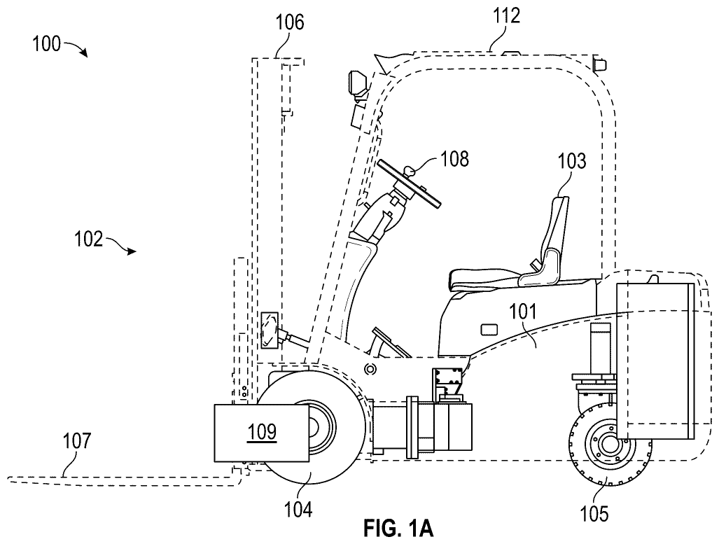

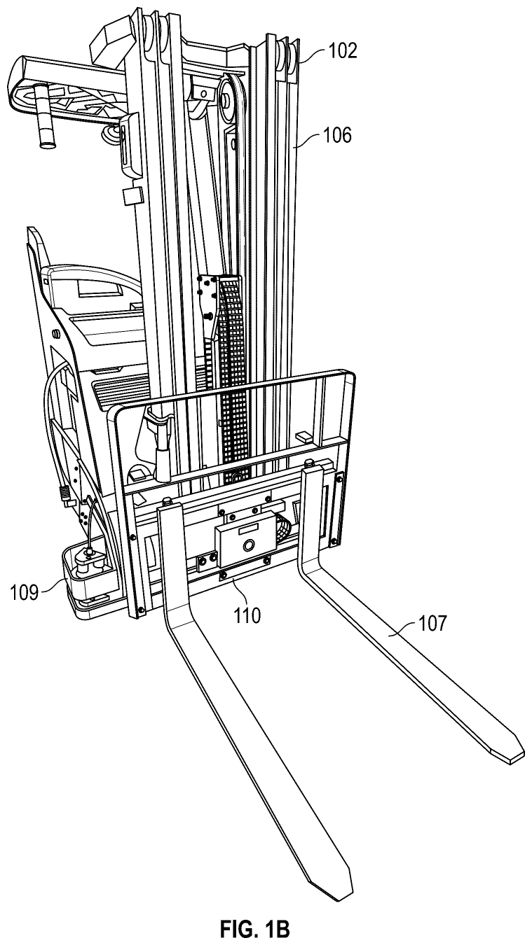

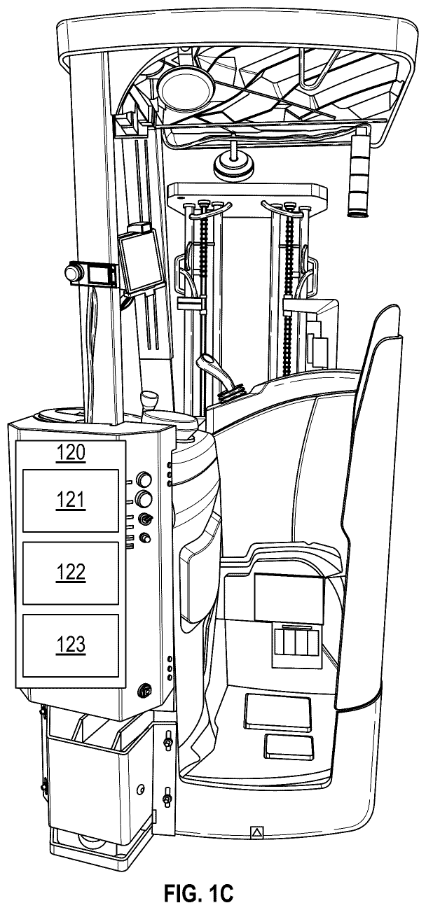

In the following description of FIGS. 1-13, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a horizontal beam” includes reference to one or more of such beams.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope of the invention should not be considered limited to the specific arrangement of steps shown in the flowcharts.

In one or more embodiments, a system presented in this disclosure relates to an automated forklift designed for trailer loading and unloading operations, as well as associated behaviors needed in the immediate vicinity of the loading dock such as upstacking, downstacking, and interacting with conveyors.

In one or more embodiments disclosed herein, the forklift is designed to operate as either a manual forklift or a fully autonomous mobile robot (AMR), selecting between these modes with the flip of a switch. Throughout this disclosure, the terms AMR, forklift, and vehicle may be used interchangeably. In autonomous mode (AMR), computerized control system senses elements within the environment and establishes the drive commands to safely and expeditiously carry out a pallet handling operation. In the AMR mode, the manual controls are ignored. For safety, the operator compartment is monitored, and in case the operator attempts to operate the vehicle while it is in autonomous mode, the vehicle (i.e., forklift) halts.

In addition, rather than requiring an extensive site survey and detailed maps to be prepared for each site, and rather than requiring substantial IT infrastructure integration, the forklift may be installed in a new facility in about an hour with just a couple of visual fiducial markers added to a dock door and about 10 measurements taken by hand with a tape measure. Additionally, as complex computer systems stay online for long durations, errors tend to accumulate, and more unexpected states can be reached. The forklift does not rely on a significant state being stored from one task to the next.

In one or more embodiments, the forklift may experience challenges when dealing with non-flat ramps that require non-constant mast poses to accurately insert the robot fork tines into the pockets of the pallet support and successfully pick the pallet. Such pallets may be located adjacent to the tail of a truck. Additionally, handling increased obstacles such as, at least, weather guards and ramp walls around the pick-up zone makes it both difficult to cleanly insert the forks and cleanly extract the tail-adjacent pallets from around the obstacles.

More specifically, the tail-adjacent pallets consist of all pallets where the vehicle must be partially or fully on the ramp while picking. For example, we consider the initial rows of pallets to be tail pallets.

This disclosure describes two tail-adjacent pallet picking approaches to manipulate the configuration of the forks and mast during ramp transit and insertion into the pallet. Specifically, the approaches include a feed-forward control of mast trajectories via model-based mast trajectory planning and a feedback control of mast positions via pallet pocket detection and visual servoing. However, the two methods are not necessarily exclusive and can be used in combination.

In one or more embodiments, the advantages of the feed forward control approach are that rapid changes in fork position caused by ramp transit can be predicted and controlled in advance, which is particularly significant during the lip bevel transition. Further, the position of the pallet does not need to be measured precisely, as we can predict that it will be on the floor of the trailer and plan accordingly.

Further, the advantages of the feedback control approach are that the unexpected variations in the environment such as those caused by a bad ramp model or improperly estimated vehicle dynamics can be automatically compensated for. Additionally, the feedback control approach does not require learning or configuring a model of the ramp.

FIGS. 1A-1C show an automated stand-up counterbalanced three-wheeled forklift vehicle (100), in accordance with one or more embodiments of the invention. The stand-up counterbalanced three-wheeled forklift vehicle is a type of forklift vehicle that comprises a single rear wheel and two front wheels. In one or more embodiments the single rear wheel may serve as a driving force provider, while the two front wheels may serve as stabilizers. Further, the stand-up counterbalanced three-wheeled design of a forklift may enhance the maneuverability of the forklift vehicle to navigate in various environments. For example, the stand-up counterbalanced three-wheeled forklift is able to turn in a narrower space than a four-wheeled forklift.

Turning to FIG. 1A, the forklift (100) includes a vehicle body (101) and a load-handling system (102) that is coupled to the front of the vehicle body (101). An operator's compartment (103) is provided in the center of the vehicle body (101). In one or more embodiments, an operator's compartment (103) may be installed to enable a manual operation of the forklift, in addition to autonomous operations. The operator's compartment may enable the operator to control the forklift in a seating or standing position. Alternatively, in some embodiments, the forklift may be fully autonomous, without the operator's compartment (103).

Additionally, the operator's compartment (103) may include a driver's seat on which the operator of the forklift (100) is seated. Further, the vehicle body (101) has an engine hood and the driver's seat may be positioned on the engine hood. An acceleration pedal may be provided on the floor of the operator's compartment (103) for controlling the speed of the forklift (100).

In one or more embodiments, a manual control system is located in the operator's compartment. Specifically, a steering wheel (108) for steering the forklift (100) may be located in front of the driver's seat. A forward and backward control lever for selecting the forward or backward movement of the forklift (100) may also be located next to the steering wheel (108). A lift control lever for operating the lift cylinders and a tilt control lever for operating the tilt cylinders may also be located next to the steering wheel (108).

In one or more embodiments, a display device (e.g., monitor) may be located in the operator's compartment (103). The vehicle monitor may have a monitor screen such as an LCD or an EL display, for displaying data obtained by a camera or images generated by a processor. The monitor may be a tablet, a smart phone, a gaming device, or any other suitable smart computing device with a user interface for the operator of the AMR/vehicle. In one or more embodiments, the monitor is used to maneuver and control navigation of the forklift (100). The user interface elements, such as buttons and/or switches are available on a dashboard and on the joystick to control features such as the horn (263) and headlights.

The vehicle body (101) stands on two pairs of wheels. Specifically, the front pair of wheels are drive wheels (104) and the rear pair of wheels are steer wheels (105). The drive wheels (104) provide the power to move the forklift (100) forward or backward. Further, the drive wheels (104) may move only in two directions (e.g., forward and backward) or turn under a plurality of angles. Additionally, the steering wheels (105) may be responsible for changing the direction of the forklift (100). The steering wheels (105) may be controlled by a steering wheel (108) located in front of the driver's seat. The forklift (100) may be powered by an engine using an internal combustion. The engine may be installed in the vehicle body (101). The vehicle body (101) may include an overhead guard (112) that covers the upper part of the operator's compartment (103).

Further, the load-handling system (102) includes a mast (106). The mast may include inner masts and outer masts, where the inner masts are slidable with respect to the outer masts. In some embodiments, the mast (106) may be movable with respect to vehicle body (101). The movement of the mast (106) may be operated by hydraulic tilt cylinders positioned between the vehicle body (101) and the mast (106). The tilt cylinders may cause the mast (106) to tilt forward and rearward around the bottom end portions of the mast (106). Additionally, a pair of hydraulically-operated lift cylinders may be mounted to the mast (106) itself. The lift cylinders may cause the inner masts to slide up and down relative to the outer masts.

Further, a right and a left fork (107) are mounted to the mast (106) through a lift bracket, which is slidable up and down relative to the inner masts. In one or more embodiments embodiment, the inner masts, the forks (107), and the lift bracket are part of the lifting portion. The lift bracket is shiftable side to side to allow for accurate lateral positioning of the forks and picking of flush pallets. In some embodiments, the lift bracket side shift actuation is performed by hydraulically actuated cylinders. Alternatively, the lift bracket is driven by electric linear actuators.

In one or more embodiments, a sensing unit (109) may be attached to the vehicle body (101). Alternatively, the sensing unit may be attached to the forks or the mast. The sensing unit (109) may include a plurality of sensors including, at least, an Inertial Measurement Unit (“IMU”), Light Detection and Ranging (“LiDAR,”) encoders, and a camera system including at least one camera. The IMU (109) combines a plurality of sensors (e.g., accelerometer, gyroscope, magnetometer, pressure sensor . . . ) to provide data regarding the forklift's (100) orientation, acceleration, and angular velocity. More specifically, the accelerometer of the IMU may measure linear acceleration to determine changes in velocity and direction. Further, the gyroscope of the IMU may measure rotational movements and the magnetometer detects the Earth's magnetic field to determine orientation information as well as the angle of tilt of the forklift (100). The encoders may be used to determine the position of the forks.

In one or more embodiments, the sensors (109) may include an odometer. The odometer measures the distance traveled by the entire vehicle or a singular wheel. The orientation of a vehicle may be determined based on calculations of different distances covered by each wheel. The calculations may be based on measuring the rotation of the wheels. Further, by tracking the number of wheel revolutions and the diameter of the wheel, the total distance covered by each wheel may be calculated.

Further, the LiDAR uses laser light beams to measure the distance between the forklift (100) and surrounding objects. Specifically, the LiDAR emits laser beams and measures the time needed for the beams to bounce back after hitting the target. Based on the measurements, the LiDAR may generate a 3D map of surrounding environment. The LiDAR may be used to help the forklift (100) to navigate along a path to pick up pallets from the loading dock of a trailer and to drop them off in a designated spot (a final destination), such as in a warehouse or storage facility. The LiDAR may also be used, during this navigation, to detect and avoid surrounding obstacles (i.e., persons, objects, other forklifts, etc.). In one or more embodiments, there may be two or three LiDAR sensors on the forklift (100). In one or more embodiments, the LiDAR sensors disposed on the forklift (100) may be protected by guards which protrude over and/or surround the LiDAR sensors.

Turning to FIG. 1B, the forklift (100) includes a camera (110). The camera (110) may be a line scan or area scan camera, a CCD camera, a CMOS camera, or any other suitable camera used in robotics. The camera (110) may capture images in monochrome or in color. Physically, the camera (110) may be located on the front side of the forklift (100) to be able to capture the position of the forks (107), as well as the surrounding environment that faces the forward movement direction of the forklift. Additionally, one or more cameras may be located on each side of the forklift to monitor the surroundings and potential obstacles. The camera (110) is able to process raw image data, present it on a display, and/or store it in a database. There may be one or more cameras disposed on the forklift (100).

In one or more embodiments, the camera setup (110) may be a stereo pair camera setup, where the stereo pair camera setup may include one or more cameras positioned on the left and the right front side of the forklift (100). Such setup captures sightly offset images enabling capturing a dept perception. The dept perception allows further calculations of depth information. By analyzing the disparities between the images, a 3D image may be constructed.

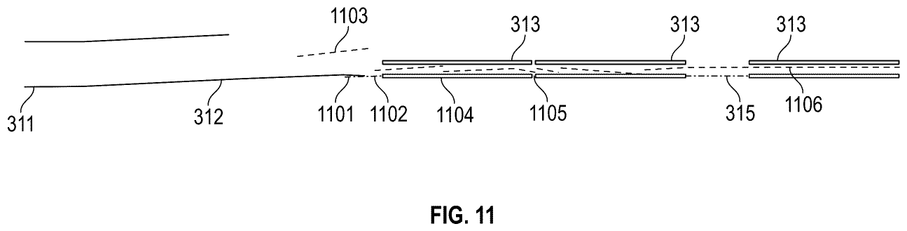

Turning to FIG. 1C, a control system (120) is included at the back part of the forklift (100). The control system may include a microcontroller (121), a battery (122), and a communication module (123). In one or more embodiments, the control system is a PC or computing device such as that shown in FIG. 11. The microcontroller (121) may be one or more processors, a Field Programmable Gate Array (FPGA), or other off-the-shelf microcontroller kits that may include open-source hardware or software. The battery (122) may be an extended life battery allowing the robot to operate continuously. The communication module (123) may support one or more of a variety of communication standards such as Wi-Fi, Bluetooth, and other suitable technologies compatible with communicating control and data signals from the forklift (100) to external systems and back. The external systems may include the operator, the human interface module, or any other agent.

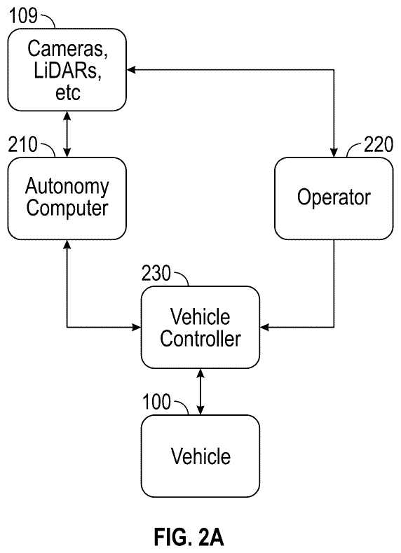

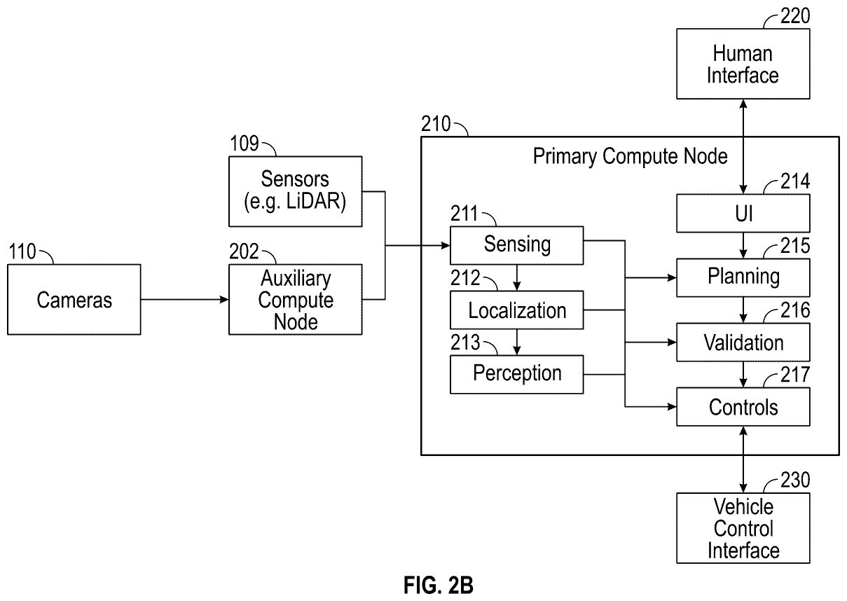

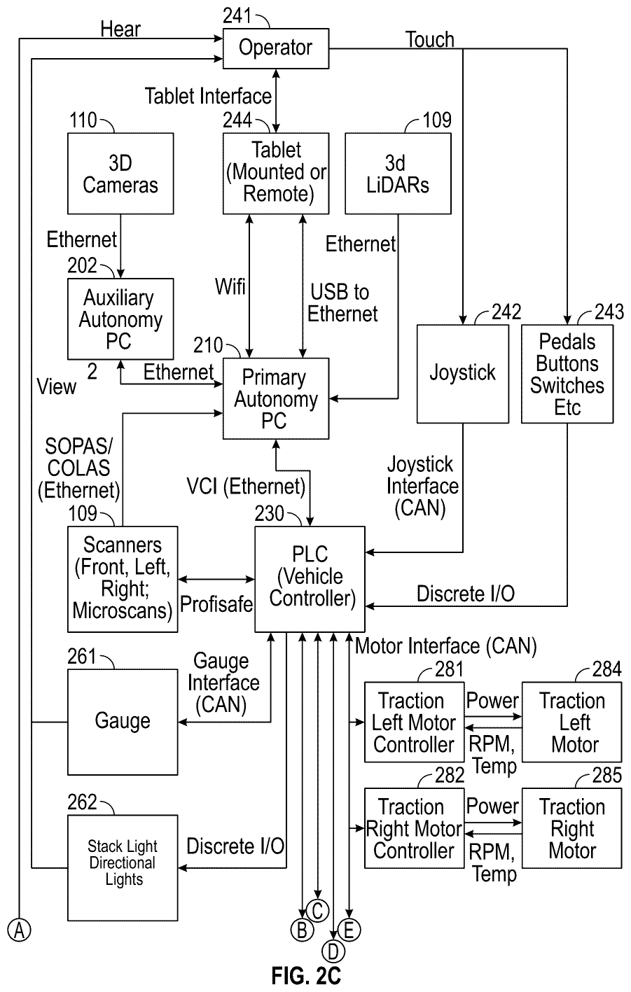

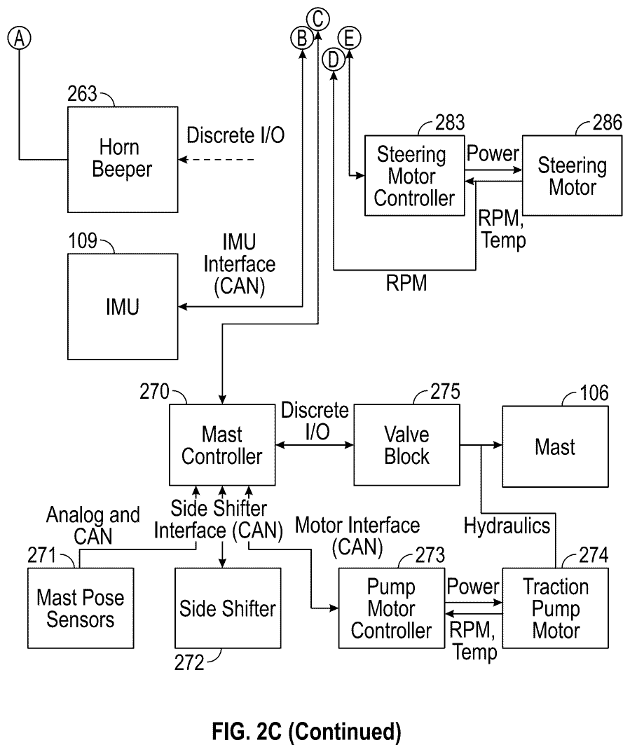

FIG. 2A shows an architecture for two sources of control of the forklift (100). In one or more embodiments, the forklift (100) may be controlled manually and autonomously, as an AMR. Specifically, a human operator (220) may sense the environment directly or remotely. For example, the human operator may interact with the forklift manually while sitting in the operator's compartment (103) and using the wheel, the forward and backward control lever, the lift control lever, and the tilt control lever. Alternatively, the human operator (220) may interact with the forklift (100) remotely. Specifically, the human operator (220) may receive a visual input from a camera (110), or a computer-generated image based on the sensors (109) and use this sensor information to navigate the forklift.

In one or more embodiments, an autonomy computer (210) is fed with sensor data (109), as shown on FIG. 2B. The sensor data may be received preprocessed by an auxiliary computer (202), before being inputted into the sensing module (211) of the autonomy computer (210). The auxiliary computer may contain a specialized hardware for a deep learning inference analysis. The auxiliary computer (202), the autonomy computer (210), and the vehicle controller (230) may be any suitable computing device, as shown and described in FIG. 11, for example.

Additionally, together with the sensor data (109), the input may be received through the human interface (220). In some embodiments, the human interface (220) may be a ruggedized tablet. The human interface may display information to the operator and serve as an interface from which an operator determines the task for the forklift (100) to perform. The human interface (220) is detachable from the forklift (100) to allow issuing commands or monitoring of operation by a person remotely, outside of the operator's compartment (103). Additionally, issuing the commands may be accomplished through an application programming interface (API) to allow integration with a facility's warehouse management system (WMS).

Continuing with FIG. 2B, the autonomy computer (210) includes a plurality of modules, including a sensing module (211), a localization module (212), a perception module (213), a user interface module (214), a planning module (215), a validation module (216), and a controls module (217). The autonomy computer analyses the input data and based on the analysis generates commands transmitted to the vehicle controller (230) (e.g., unloading a trailer).

More specifically, the sensing module (211) collects the input data from various sensor sources (109) and time-correlating the input data, to enable other modules to operate based on the output, which is a coherent view of the environment at one instant in time.

Further, the localization module (212) is responsible for the simultaneous localization of the robot and mapping of its environment, based on, at least, the data obtained by the sensing module (211). The mapping process may be supplemented by measurements recorded during a site survey. The localization may include determining a position and orientation of the forklift (100). Specifically, the IMU data may be used to determine the forklift's acceleration and rotation movements, as well as the tilt of the forklift (100).

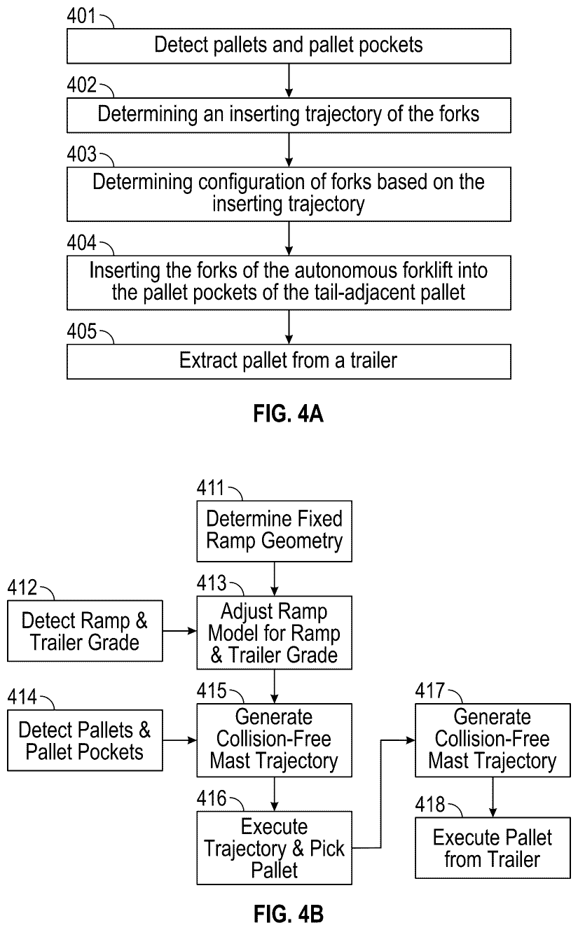

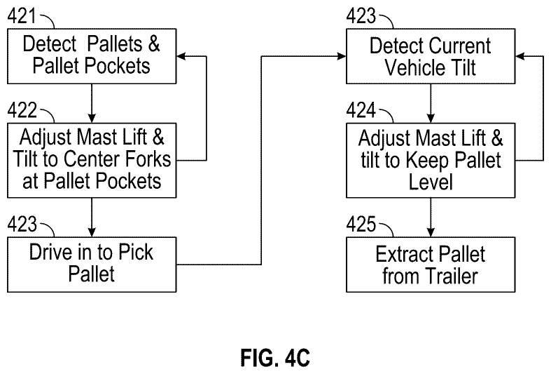

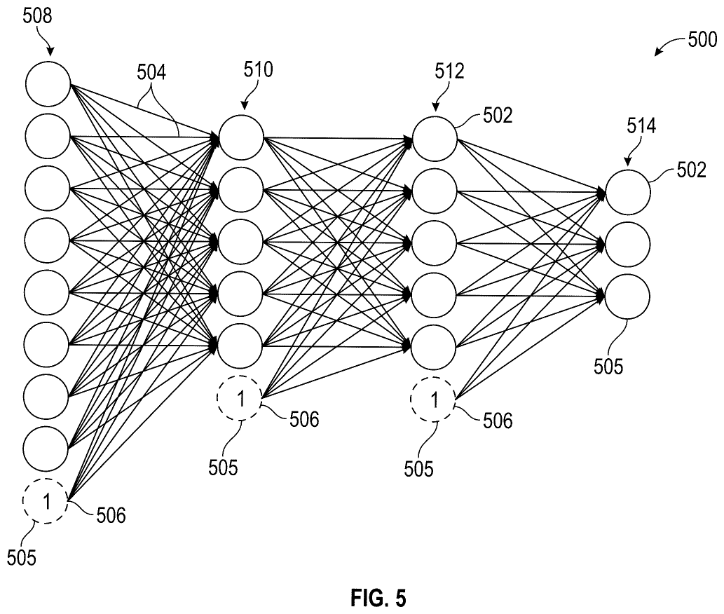

The perception module (213) analyzes and contextualizes the sensor data and identifies key objects within the environment, such as pallets and trailers. The identification is accomplished with a combination of classical and neural network-based approaches, further explained in FIGS. 4 and 5. Specifically, the perception module uses the machine learning model and the obtained data to determine a location of an entrance door to a trailer, a plurality of pallets' face-side pockets, and a plurality of pallets' face-side pockets.

The user interface (“UI”) module (214) may be responsible for interfacing with the human interface module (220). The UI module (214) may notify the human interface module about the status of the forklift (100), including the location, orientation, tilt, battery level, warning, failures, etc. Further, the UI module (214) may receive a plurality of tasks from the human interface module (220).

Further, the planning module (215) is responsible for executing the deliberative portions of forklift's (100) task planning. Initially, the planning module (215) determines what action primitive should be executed next in order to progress towards a goal. Specifically, the action primitive refers to an elementary action performed by the forklift (100) that builds towards a more complex behavior or task, such as picking a pallet as a primitive that works towards unloading a truck. Further, the planning module (215) employs a hybrid search, sampling, and optimization-based path planner to determine a path that most effectively accomplishes a task, such as adjusting a configuration of a plurality of forks based on the determined position of the plurality of forks with respect to the plurality of pallets' face-side pockets and determining a final position of the pallet using the machine learning model based on the obtained data.

Additionally, the validation planning module (216) is a reactive planning component which runs at a higher frequency than the planning module (215). The validation planning module (216) avoids near-collisions that would cause the vehicle controller (230) to issue a protective stop. Further, the validation planning module (216) is also responsible for determining any aspects of the plan that were not specified by the slower-running planning loop (e.g., exact mast poses that cannot be known until the forklift is about to execute a pick or place action).

Additionally, the controls module (217) is a soft real-time component that follows the refined plan that was emitted by the validation planning module (216). The controls module (217) module is responsible for closing any gap that arises from the difference between a planned motion and the motion that is actually carried out, due to real-world imprecisions in vehicle control.

The autonomy computer (210) and the human interface (220) are two control sources that feed into the vehicle controller (230). The vehicle controller (230) analyses the control inputs that it receives to enforce safety prerequisites of operation of the forklift. In autonomous mode, the analysis includes monitoring for any potential collisions, which are detected through sensors that communicate directly with the vehicle controller (230). After the commands have been validated, they are forwarded to the discrete controllers that execute the commanded motion.

In one or more embodiments, the vehicle controller (230) may employ an input-process-output model. The vehicle controller (230) receives a plurality of inputs from a plurality of sensors and controllers. More specifically, the status of each of the motors of the forklift (100) may be monitored via a motor controller, which reports to the vehicle controller (230) via a controller area network (“CAN”) bus (not shown). Further, the status of the mast is monitored by a discrete controller, which also reports via a CAN bus. The input from the user may be received through a user interface or a joystick that is also connected via a CAN bus. In some embodiments, the user interface inputs (e.g., button and switch inputs) are received through safety rated and non-safety rated inputs, as appropriate for the type of signal they represent.

Further, the commands from the autonomy computer (210) may be received via a direct ethernet link using a combination of transmission control protocol (“TCP”) and user datagram protocol (“UDP”). Additionally, the sensors used to monitor the forklift's environment may report information through the safety rated protocols built on TCP and UDP.

Additionally, the vehicle controller (230) may process the data in two sub-modules including a main program and a safety program. Specifically, the main program processes the majority of the tasks. Within this program, the vehicle controller establishes the state of the forklift (100) and determines what commands should be sent to controllers. Further, the diagnostic and reporting of the information is handled in this program and further transmitted or recorded.

The safety program provides a safety guarantee to the vehicle controller and enforces the guarantee. For example, the user interface may employ stop buttons to stop the forklift's (100) motion in both autonomous and manual mode. Additionally, the forklift may have a physical button to stop the forklift's operation. The safety program is much less expressive as a programming environment, and as a result, it is much simpler to analyze, allowing it to be used as the foundation of safety features of the forklift (100).

In one or more embodiments, the vehicle controller (230) has a plurality of outputs including commands for motor performance and commands for mast performance, both sent via the CAN bus and information regarding the status of the vehicle sent to the primary autonomy computing node via TCP and UDP. Further, the vehicle controller (230) transmits discrete controls using safety rated and non-safety rated outputs. Therefore, a redundant safety rated relay uses all motive power to the forklift (100) and is controlled via a safety rated output. The safety rated outputs are controlled directly by the safety program.

FIG. 2C shows components of the forklift system (100) and their interconnections. Specifically, the manual mode includes an operator (241) controlling the forklift directly through a joystick (242) or physical buttons, pedals, switches, etc. (243) Additionally, the operator (241) may interact with an operator's tablet (244) to directly control the forklift (100) or to assign tasks to the forklift (100). The assigned tasks are carried out by the autonomy computer (210) which utilizes machine learning models to generate autonomous instructions for the forklift (100). The autonomy computer (210) generates the instructions based on the input received from the camera (110) through the auxiliary autonomy computer (202), sensors (109), and the operator's tablet (244), which may be connected to the autonomy computer (210) through an ethernet cable or wirelessly.

The outputs of the autonomy computer (210), joystick (242), physical buttons, pedals, and switches, (243), as well as the sensors (109), are used as input to a vehicle controller (230). The vehicle controller interfaces with traction left (281) and right (282) motor controllers controlling traction left motor (284) and traction right motor (285), and a steering motor controller (283) controlling the steering motor (286).

Additionally, the vehicle controller (230) interfaces with the mast controller (270) which receives input from mast pose sensors (271) and interfaces with controllers controlling the movement of the mast (106) and forks (107) including a side shifter (272), a pump motor controller (273), a traction pump motor (274), a valve block (275), and the mast (106).

The vehicle controller (230) may notify the operator (241) about the state of the forklift using a gauge (261) consisting of stacked lights (262) with a plurality of colors, where each color combination represents a different predefined message to the operator (241), and a horn beeper which is used in a case of an alarm.

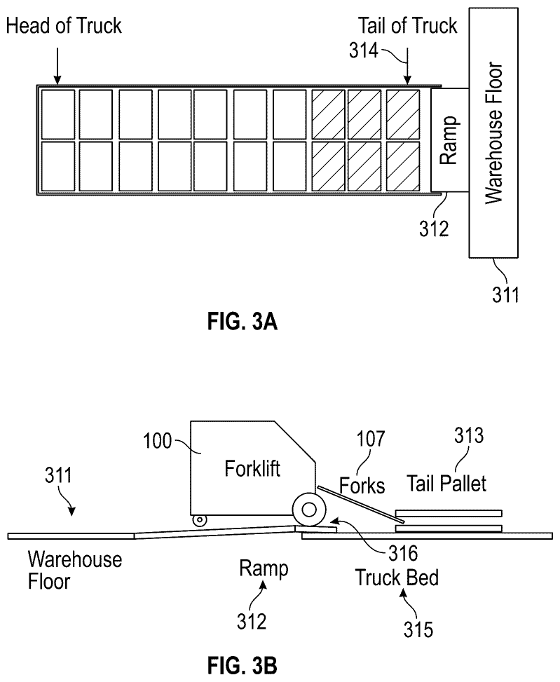

FIGS. 3A and 3B show diagrams of the tail-adjacent pallet lifting process in accordance with one or more embodiments. Specifically, when the vehicle is driving on the ramp (312), the vehicle approaches tail-adjacent pallets (313) located at a tail of a trailer bed (e.g., truck bed) (314) of a trailer. Specifically, the ramp (312) may be a pit leveler, edge of dock leveler, dock plate, or any other material connecting the warehouse floor to the interior of the trailer. Additionally, the trailer may be a dry van semi-trailer, refrigerated semi-trailer, intermodal shipping container, or any other container used for the storage and/or transportation of pallets externally to a facility.

Further, FIG. 3C shows that the forks (107) may need to be configured to be able to enter the tail-adjacent pallet's pockets in order to lift the tail-adjacent pallet (313). When the forks (107) are not configured properly, the result may be that the forks (107) damage the transported loads, the trailer bed (315) or the forks may be damaged themselves.

In one or more embodiments, the configuration of the fork may represent adjustment of the fork and the mast with respect to the vehicle body (101). The configuration of the fork may have three degrees of freedom, including lift, tilt, and side shift. In some embodiments, the side shift may be adjusted using linear actuators to shift the carriage left or right. Additionally, the configuration of the fork may include a fourth degree of freedom including spread. Specifically, the spread of the fork represents the distance between the two tines of the fork.

FIG. 4A shows a flowchart in accordance with one or more embodiments. Specifically, the flowchart illustrates a method for an autonomous unloading of tail-adjacent pallets. Further, one or more blocks in FIG. 4A may be performed by one or more components as described in FIGS. 1-3. While the various blocks in FIG. 4A are presented and described sequentially, one of ordinary skill in the art will appreciate that some or all of the blocks may be executed in a different order, may be combined or omitted, and some or all of the blocks may be executed in parallel. Furthermore, the blocks may be performed actively or passively.

In Step S401, data may be obtained using from an operator or from a camera (110) and sensors (109). In one or more embodiments, the obtained data may include length of a ramp, angle of the ramp, angle of a trailer floor, height of a trailer floor bedding, size of pallet's pockets, etc. Specifically, the obtained data may be measured by an operator prior to operation of the unloading process. Alternatively, the sensors (109) may be used to obtain the data. For exemplary purposes, IMU may be used to estimate the ramp angle. The IMU requires the vehicle to be on, at least, partially on the ramp.

Additionally, the forklift (100) utilizes a plurality of sensors in real time. More specifically, the forklift (100) logs its position, orientation, tilt, and speed using the IMU. Additionally, the forklift (100) uses LiDAR to scan its surrounding and map all potential obstacles in its environment. In one or more embodiments, the forklift (100) may adjust the scanning of the environment in response to control signaling from the operator to regulate the scanning.

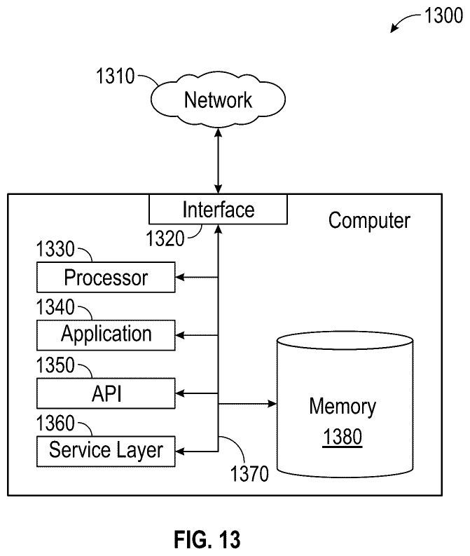

Additionally, camera (110) may be a part of a bigger manual or automatic system, such as the forklift camera. The camera may obtain accurate measurements from the warehouse floor (311) provided the vehicle, or more specifically, the housing the of the camera (110), is close to the ramp. The obtained raw image data may be, at least, a binary image, a monochrome image, a color image, or a multispectral image. The image data values, expressed in pixels, may be combined in various proportions to obtain any color in a spectrum visible to a human eye. In one or more embodiments, the image data may have been captured and stored in a non-transient computer-readable medium as described in FIG. 13. The captured image may be of any resolution. Further, the video is determined to be a sequence of images played at a predetermined frequency, which is expressed by frames per second. Further, the videos are processed by extracting frames as images and processing them independently of each other.

In one or more embodiments, the raw image data may be processed using a machine learning model. The machine learning model may be used to recognize different objects by assigning a label to the object. In some embodiments, the machine learning model may be used to determine the location of the pallets, the location of the pallet pockets, the size of the pallet pockets, the width of the ramp, and aid in determining location of the forklift with respect to the ramp, pallets, or the trailer entrance.

In one or more embodiments, the feed forward mast planning may be used to determine the configuration of the forks. The feed forward mast planning requires several methods to determine the configuration of the forks, including modeling the prior geometry of the ramp independent of the angle deployed in a trailer bed, estimating the ramp angle to model the ramp geometry as-deployed for a particular trailer, and planning the mast trajectory to perform a collision-free pick.

The feed forward approach may require a model of a ramp (312) and a ramp lip (316) to model the motion of the forklift (100) and forks (107) as it transits into a trailer. The geometry of the ramp may vary significantly from dock to dock. For example, edge-of-dock levelers have significantly different geometry from pit levelers as there is no lip separate from the ramp itself. Although, a majority of ramps (312) are based on a pit leveler geometry, the ramps (312) may vary between themselves. Even dock levelers with similar dimensions may have slightly different geometry due to differences in the manufacturing process.

Most aspects of ramp geometry will be consistent for all trailers unloaded from the same dock. The variables, denoted as fixed ramp geometry, may include, at least, a length and width of the ramp (312), angle between the ramp (312) and the ramp lip (316), and steepness and shape of the ramp lip (316) and the ramp lip level. The fixed ramp geometry is defined as the parameters of the ramp that do not vary between different loading and unloading operations. In one or more embodiments, the fixed ramp geometry may be obtained manually without sensors, manually with minimal sensor input, or using a plurality of sensors.

In one or more embodiments, the feed forward mast planning method may determine the fixed ramp geometry using different procedures. The fixed ramp geometry may be obtained as a plurality of hand-measured variables such as ramp length and width, relative tilt of ramp lip, etc. The hand-measured variables may be measured and inputted by the vehicle operator during the configuration of the dock door. Alternatively, some characteristics, such as ramp lip shape, may be similar across most common dock leveler manufacturers and their specifications may be pre-programmed into the forklift system. Further, a plurality of sensors may be used to measure a variable geometry of the ramp (e.g., a tilt of a ramp), where the variable geometry of the ramp is defined as parameters of the ramp that vary between different loading and unloading operations. The variable geometry of the ramp may include, at least, the tilt of the ramp, a position of a dock leveler, and a tilt of the trailer bed.

In some embodiments, the machine learning may be used to generate a full surface contour model based on sensor measurements. The sensor measurements may be gathered during a repeated ramp transit. Generating the full surface contour modeling may include generating a model of different components' surfaces, including ramp and trailer surfaces and other fixed ramp geometry. The full surface contour model yields the highest precision and customization to specific dock levelers. Alternatively, the full surface contour model can be detected using a combination of depth camera observations and IMU tilt measurements, and then combined statistically to build a high-confidence aggregate model that is independent of ramp angle. Additionally, hand-measured variables and ramp specification may be combined with the full surface contour model to provide good initial measurements that are refined based on observed data.

Further, the ramp (312) has a contour, which is the piece of the ramp (312) in contact with the truck bed. The modeling software generated configuration accounts for this contour in a generic manner, where a fixed length and shape is assumed. Specifically, when the vehicle commands the mast pairs (e.g., height and tilt) the vehicle is able to successfully pick tail-adjacent pallets. The obtained mast pairs may vary based on different models of forklifts used, as well as the dimensions and set up a ramp (312), trailer, and pallets.

Machine learning (ML), broadly defined, is the extraction of patterns and insights from data. The phrases “artificial intelligence,” “machine learning,” “deep learning,” and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term machine learning, or machine-learned, will be adopted herein. However, one skilled in the art will recognize that the concepts and methods detailed hereafter are not limited by this choice of nomenclature.

Machine-learned model types may include, but are not limited to, generalized linear models, Bayesian regression, random forests, and deep models such as neural networks, convolutional neural networks, and recurrent neural networks. Machine-learned model types, whether they are considered deep or not, are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. Commonly, in the literature, the selection of hyperparameters surrounding a machine-learned model is referred to as selecting the model “architecture.” Once a machine-learned model type and hyperparameters have been selected, the machine-learned model is trained to perform a task.

Herein, a cursory introduction to various machine-learned models such as a neural network (NN) and convolutional neural network (CNN) are provided as these models are often used as components—or may be adapted and/or built upon—to form more complex models such as autoencoders and diffusion models. However, it is noted that many variations of neural networks, convolutional neural networks, autoencoders, transformers, and diffusion models exist. Therefore, one with ordinary skill in the art will recognize that any variations to the machine-learned models that differ from the introductory models discussed herein may be employed without departing from the scope of this disclosure. Further, it is emphasized that the following discussions of machine-learned models are basic summaries and should not be considered limiting.

A diagram of a neural network is shown in FIG. 5. At a high level, a neural network (500) may be graphically depicted as being composed of nodes (502), where here any circle represents a node, and edges (504), shown here as directed lines. The nodes (502) may be grouped to form layers (505). FIG. 5 displays four layers (508, 510, 512, 514) of nodes (502) where the nodes (502) are grouped into columns, however, the grouping need not be as shown in FIG. 5. The edges (504) connect the nodes (502). Edges (504) may connect, or not connect, to any node(s) (502) regardless of which layer (505) the node(s) (502) is in. That is, the nodes (502) may be sparsely and residually connected. A neural network (500) will have at least two layers (505), where the first layer (508) is considered the “input layer” and the last layer (514) is the “output layer.” Any intermediate layer (510, 512) is usually described as a “hidden layer.” A neural network (500) may have zero or more hidden layers (510, 512) and a neural network (500) with at least one hidden layer (510, 512) may be described as a “deep” neural network or as a “deep learning method.” In general, a neural network (500) may have more than one node (502) in the output layer (514). In this case the neural network (500) may be referred to as a “multi-target” or “multi-output” network.

Nodes (502) and edges (504) carry additional associations. Namely, every edge is associated with a numerical value. The edge numerical values, or even the edges (504) themselves, are often referred to as “weights” or “parameters.” While training a neural network (500), numerical values are assigned to each edge (504). Additionally, every node (502) is associated with a numerical variable and an activation function. Activation functions are not limited to any functional class, but traditionally follow the form

$$A = f ( {\sum }_{i ∈ ( incoming )} [ {( node value )}_{i} {( edge value )}_{i} ] ) , \qquad ( 2 )$$

where i is an index that spans the set of “incoming” nodes (502) and edges (504) and f is a user-defined function. Incoming nodes (502) are those that, when viewed as a graph (as in FIG. 5), have directed arrows that point to the node (502) where the numerical value is being computed. Some functions for f may include the linear function f(x)=x, sigmoid function

$$f ( x ) = \frac{1}{1 + {e}^{- x}} ,$$

and rectified linear unit function f(x)=max (0,x), however, many additional functions are commonly employed. Every node (502) in a neural network (500) may have a different associated activation function. Often, as a shorthand, activation functions are described by the function f by which it is composed. That is, an activation function composed of a linear function f may simply be referred to as a linear activation function without undue ambiguity.

When the neural network (500) receives an input, the input is propagated through the network according to the activation functions and incoming node (502) values and edge (504) values to compute a value for each node (502). That is, the numerical value for each node (502) may change for each received input. Occasionally, nodes (502) are assigned fixed numerical values, such as the value of 1, that are not affected by the input or altered according to edge (504) values and activation functions. Fixed nodes (502) are often referred to as “biases” or “bias nodes” (506), displayed in FIG. 5 with a dashed circle.

In some implementations, the neural network (500) may contain specialized layers (505), such as a normalization layer, or additional connection procedures, like concatenation. One skilled in the art will appreciate that these alterations do not exceed the scope of this disclosure.

As noted, the training procedure for the neural network (500) comprises assigning values to the edges (504). To begin training the edges (504) are assigned initial values. These values may be assigned randomly, assigned according to a prescribed distribution, assigned manually, or by some other assignment mechanism. Once edge (504) values have been initialized, the neural network (500) may act as a function, such that it may receive inputs and produce an output. As such, at least one input is propagated through the neural network (500) to produce an output. Training data is provided to the neural network (500). Generally, training data consists of pairs of inputs and associated targets. The targets represent the “ground truth,” or the otherwise desired output, upon processing the inputs. During training, the neural network (500) processes at least one input from the training data and produces at least one output. Each neural network (500) output is compared to its associated input data target. The comparison of the neural network (500) output to the target is typically performed by a so-called “loss function;” although other names for this comparison function such as “error function,” “misfit function,” and “cost function” are commonly employed. Many types of loss functions are available, such as the mean-squared-error function, however, the general characteristic of a loss function is that the loss function provides a numerical evaluation of the similarity between the neural network (500) output and the associated target. The loss function may also be constructed to impose additional constraints on the values assumed by the edges (504), for example, by adding a penalty term, which may be physics-based, or a regularization term. Generally, the goal of a training procedure is to alter the edge (504) values to promote similarity between the neural network (500) output and associated target over the training data. Thus, the loss function is used to guide changes made to the edge (504) values, typically through a process called “backpropagation.”

While a full review of the backpropagation process exceeds the scope of this disclosure, a brief summary is provided. Backpropagation consists of computing the gradient of the loss function over the edge (504) values. The gradient indicates the direction of change in the edge (504) values that results in the greatest change to the loss function. Because the gradient is local to the current edge (504) values, the edge (504) values are typically updated by a “step” in the direction indicated by the gradient. The step size is often referred to as the “learning rate” and need not remain fixed during the training process. Additionally, the step size and direction may be informed by previously seen edge (504) values or previously computed gradients. Such methods for determining the step direction are usually referred to as “momentum” based methods.

Once the edge (504) values have been updated, or altered from their initial values, through a backpropagation step, the neural network (500) will likely produce different outputs. Thus, the procedure of propagating at least one input through the neural network (500), comparing the neural network (500) output with the associated target with a loss function, computing the gradient of the loss function with respect to the edge (504) values, and updating the edge (504) values with a step guided by the gradient, is repeated until a termination criterion is reached. Common termination criteria are reaching a fixed number of edge (504) updates, otherwise known as an iteration counter; a diminishing learning rate; noting no appreciable change in the loss function between iterations; reaching a specified performance metric as evaluated on the data or a separate hold-out data set. Once the termination criterion is satisfied, and the edge (504) values are no longer intended to be altered, the neural network (500) is said to be “trained.”

One or more embodiments disclosed herein employ a convolutional neural network (CNN). A CNN is similar to a neural network (500) in that it can technically be graphically represented by a series of edges (504) and nodes (502) grouped to form layers. However, it is more informative to view a CNN as structural groupings of weights; where here the term structural indicates that the weights within a group have a relationship. CNNs are widely applied when the data inputs also have a structural relationship, for example, a spatial relationship where one input is always considered “to the left” of another input. Grid data, which may be three-dimensional, has such a structural relationship because each data element, or grid point, in the grid data has a spatial location (and sometimes also a temporal location when grid data is allowed to change with time). Consequently, a CNN is an intuitive choice for processing grid data.

A structural grouping, or group, of weights is herein referred to as a “filter”. The number of weights in a filter is typically much less than the number of inputs, where here the number of inputs refers to the number of data elements or grid points in a set of grid data. In a CNN, the filters can be thought as “sliding” over, or convolving with, the inputs to form an intermediate output or intermediate representation of the inputs which still possesses a structural relationship. Like unto the neural network (500), the intermediate outputs are often further processed with an activation function. Many filters may be applied to the inputs to form many intermediate representations. Additional filters may be formed to operate on the intermediate representations creating more intermediate representations. This process may be repeated as prescribed by a user. There is a “final” group of intermediate representations, wherein no more filters act on these intermediate representations. In some instances, the structural relationship of the final intermediate representations is ablated; a process known as “flattening.” The flattened representation may be passed to a neural network (500) to produce a final output. Note, that in this context, the neural network (500) is still considered part of the CNN. Like unto a neural network (500), a CNN is trained, after initialization of the filter weights, and the edge (504) values of the internal neural network (500), if present, with the backpropagation process in accordance with a loss function.

A common architecture for CNNs is the so-called “U-net.” The term U-net is derived because a CNN after this architecture is composed of an encoder branch and a decoder branch that, when depicted graphically, often form the shape of the letter “U.” Generally, in a U-net type CNN the encoder branch is composed of N encoder blocks and the decoder branch is composed of N decoder blocks, where N≥1. The value of N may be considered a hyperparameter that can be prescribed by user or learned (or tuned) during a training and validation procedure. Typically, each encoder block and each decoder block consist of a convolutional operation, followed by an activation function and the application of a pooling (i.e., downsampling) or upsampling operation. Further, in a U-net type CNN each of the N encoder and decoder blocks may be said to form a pair. Intermediate data representations output by an encoder block may be passed to, and often concatenated with other data, an associated (i.e., paired) decoder block through a “skip” connection or “residual” connection.

Another type of machine-learned model is a transformer. A detailed description of a transformer exceeds the scope of this disclosure. However, in summary, a transformer may be said to be deep neural network capable of learning context among data features. Generally, transformers act on sequential data (such as a sentence where the words form an ordered sequence). Transformers often determine or track the relative importance of features in input and output (or target) data through a mechanism known as “attention.” In some instances, attention mechanism may further be specified as “self-attention” and “cross-attention,” where self-attention determines the importance of features of a data set (e.g., input data, intermediate data) relative to other features of the data set. For example, if the data set is formatted as a vector with M elements, then self-attention quantifies a relationship between the M elements. In contrast, cross-attention determines the relative importance of features to each other between two data sets (e.g., an input vector and an output vector). Although transformers generally operate on sequential data composed of ordered elements, transformers do not process the elements of the data sequentially (such as in a recurrent neural network) and require an additional mechanism to capture the order, or relative positions, of data elements in a given sequence. Thus, transformers often use a positional encoder to describe the position of each data element in a sequence, where the positional encoder assigns a unique identifier to each position. A positional encoder may be used to describe a temporal relationship between data elements (i.e., time series) or between iterations of a data set when a data set is processed iteratively (i.e., representations of a data set at different iterations). While concepts such as attention and positional encoding were generally developed in the context of a transformer, they may be readily inserted into—and used with—other types of machine-learned models (e.g., diffusion models).

Turning to reinforcement learning, a simulator may perform one or more reinforcement learning algorithms using a reinforcement learning system to train a machine-learning model. In particular, a reinforcement learning algorithm may be a type of method that autonomously learns agent policies through multiple iterations of trials and evaluations based on observation data. The objective of a reinforcement learning algorithm may be to learn an agent policy π that maps one or more states of an environment to an action so as to maximize an expected reward J(π). A value reward may describe one or more qualities of a particular state, agent action, and/or trajectory at particular time within an operation, such as an electric power generation operation. As such, a reinforcement learning system may include hardware and/or software with functionality for implementing one or more reinforcement learning algorithms. For example, a reinforcement learning algorithm may train a policy to make a sequence of decisions based on the observed states of the environment to maximize the cumulative reward determined by a reward function. For example, a reinforcement learning algorithm may employ a trial-and-error procedure to determine one or more agent policies based on various agent interactions with a complex environment, such as a geological subsurface with various geological interfaces and different formations. As such, a reinforcement learning algorithm may include a reward function that teaches a particular action selection engine to follow certain rules, while still allowing the reinforcement learning model to retain information learned from previous simulations.

In some embodiments, one or more components in a reinforcement learning system are trained using a training system. For example, an agent policy and/or a reward function may be updated through a training process that is performed by a machine-learning algorithm. In some embodiments, historical data, augmented data, and/or synthetic data may provide a supervised signal for training an action selector engine, an agent policy, and/or a reward function, such as through an imitation learning algorithm. In another embodiment, an interactive expert may provide data for adjusting agent policies and/or reward functions.

In one or more embodiments, an imitation learning model, which is part of the reinforced learning models, may be a preferred machine learning model. The imitation learning model instead of trying to learn from the sparse rewards or manually specifying a reward function, an expert (e.g., operator) provides the model with a set of demonstrations. The agent then tries to learn the optimal policy by imitating the expert's decisions. The main component of the imitation learning model is the environment, which is essentially a Markov Decision Process (MDP). Specifically, the environment has an S set of states, an A set of actions, a P(s′|s, a) transition model, describing a probability that an action a in the state s leads to state s′, and an unknown R(s, a) reward function. The agent performs different actions in this environment based on its π policy. There is the expert's demonstrations (trajectories) τ=(s0, a0, s1, a1, . . . ), where the actions are based on the expert's policy. Finally, the loss function and the learning algorithm are two main components, in which the various imitation learning methods differ from each other.

Imitation learning may obtain the fork configuration by collecting expert driving data for various complicated situations that occur in semi-structured environments such as driving on a ramp (312). Therefore, it is not necessary to manually model the policy and tune parameters heuristically to handle such situations. The benefit of using imitation learning instead of the reinforcement learning is because reinforcement learning requires trial-and-error and heuristic reward function modeling, but with imitation learning, the algorithm can directly use the collected expert data. Additionally, reinforcement learning can typically only be applied through a simulator (which enables trial-and-error learning).

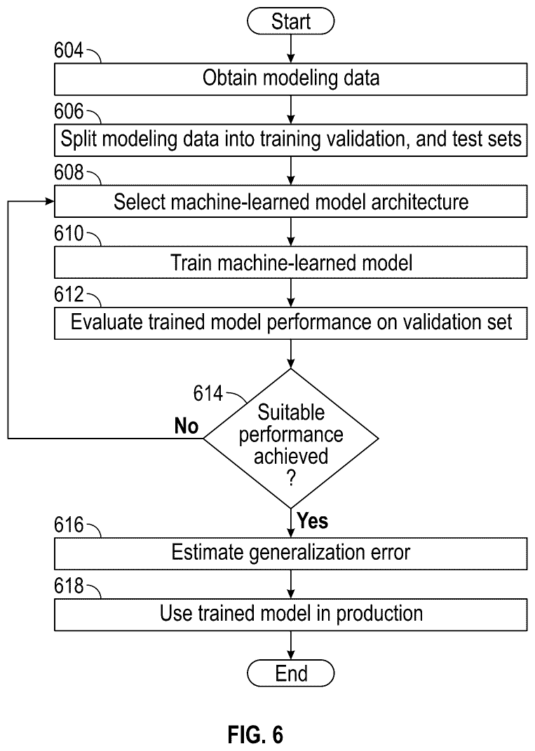

FIG. 6 depicts a general framework for training and evaluating a machine-learned model. Herein, when training a machine-learned model, the more general term “modeling data” will be adopted as opposed to training data to refer to data used for training, evaluating, and testing a machine-learned model. Further, use of the term modeling data prevents ambiguity when discussing various partitions of modeling data such as a training set, validation set, and test set, described below. In the context of FIG. 6, modeling data will be said to consist of pairs of inputs and associated targets. When a machine-learned model is trained using pairs of inputs and associated targets, that machine-learned model is typically categorized as a “supervised” machine-learned model or a supervised method. In the literature, autoencoders are often categorized as “unsupervised” or “semi-supervised” machine learning models because modeling data used to train these models does not include distinct targets. For example, in the case of autoencoders, the output, and thus the desired target, of an autoencoder is the input. That said, while autoencoders may not be considered supervised models, the training procedure depicted in FIG. 6 may still be applied to train autoencoders where it is understood that an input-target pair is formed by setting the target equal to the input.

To train a machine-learned model, modeling data must be provided. In accordance with one or more embodiments, modeling data may be collected from existing images of forklift's environment such as a warehouse, a trailer, or any other storage facility, as well as the obstacles including other forklifts, humans, walls, and misplaced equipment. Further, the data about the components of the forklift such as the forks may be supplied to the machine-learning model. In one or more embodiments, modeling data is synthetically generated, for example, by artificially constructing the environment or the forklift's components. This is to promote robustness in the machine-learned model, such that it is generalizable to new environments, components and input data unseen during training and evaluation.

Keeping with FIG. 6, in Block 604, modeling data is obtained. As stated, the modeling data may be acquired from historical datasets, be synthetically generated, or may be a combination of real and synthetic data. In Block 606, the modeling data is split into a training set, validation set, and test set. In one or more embodiments, the validation and the test set are the same such that the modeling data is effectively split into a training set and a validation/testing set. In Block 608, given the machine-learned model type (e.g., autoencoder) an architecture (e.g., number of layers, compression ratio, etc.) are selected. In accordance with one or more embodiments, architecture selection is performed by cycling through a set of user-defined architectures for a given model type. In other embodiments, the architecture is selected based on the performance of previously evaluated models with their associated architectures, for example, using a Bayesian-based search. In Block 610, with an architecture selected, the machine-learned model is trained using the training set. During training, the machine-learned model is adjusted such that the output of the machine-learned model, upon receiving an input, is similar to the associated target (or, in the case of an autoencoder, the input). Once the machine-learned model is trained, in Block 612, the validation set is processed by the trained machine-learned model and its outputs are compared to the associated targets. Thus, the performance of the trained machine-learned model can be evaluated. Block 614 represents a decision. If the trained machine-learned model is found to have suitable performance as evaluated on the validation set, where the criterion for suitable performance is defined by a user, then the trained machine-learned model is accepted for use in a production (or deployed) setting. As such, in Block 618, the trained machine-learned model is used in production. However, before the machine-learned model is used in production a final indication of its performance can be acquired by estimating the generalization error of the trained machine-learned model, as shown in Block 616. The generalization error is estimated by evaluating the performance of the trained machine-learned model, after a suitable model has been found, on the test set. One with ordinary skill in the art will recognize that the training procedure depicted in FIG. 6 is general and that many adaptations can be made without departing from the scope of the present disclosure. For example, common training techniques, such as early stopping, adaptive or scheduled learning rates, and cross-validation may be used during training without departing from the scope of this disclosure.

Turning back to FIG. 4, in one or more embodiments, the variables including a ramp and trailer bed angle estimation, will vary on a per-trailer or per-pallet basis and must be measured immediately before picking the pallet. The variables include, at least, a ramp tilt angle relative to the warehouse floor and a trailer bed tilt angle relative to the ramp or the warehouse floor.

The variables may be obtained using on-board sensors including, at least, the IMU and a depth camera (e.g., D435). The IMU requires the robot to be, at least partially, on the ramp to obtain proper scanning data. Further, the depth camera may obtain accurate measurements from the warehouse floor provided the housing the onboard camera of the robot is close to the ramp. The trailer bed angle may be measured by the depth camera, and additionally by the 3D pallet detection system, when the pallet is situated on the floor of the trailer.

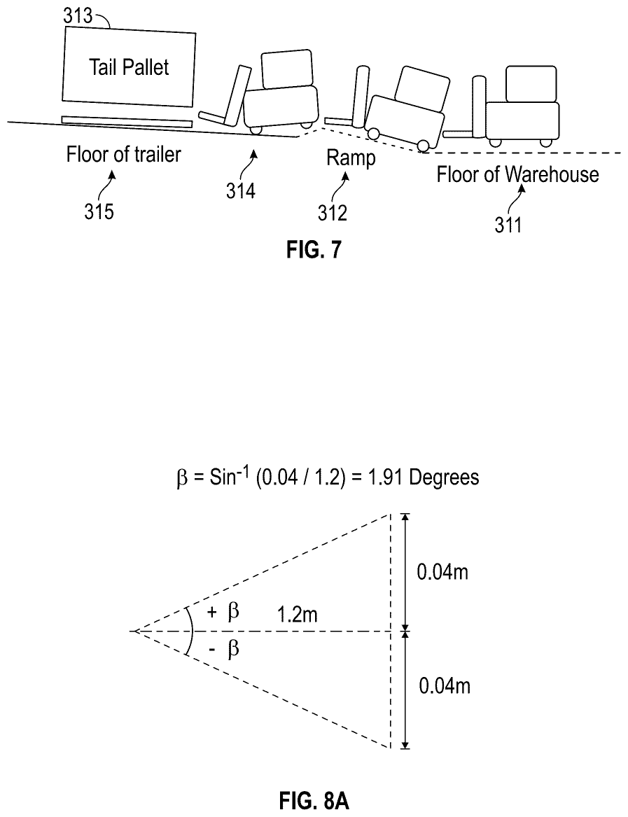

In Step S402, the collision-free inserting trajectory of the forks and the mast is determined. As shown in FIG. 7, when the vehicle is driving from the floor of the warehouse (311) to the ramp (312), the vehicle approaches tail-adjacent pallets (313) located at a tail of a floor of the trailer (e.g., truck bed) (314). Before accessing the tail-adjacent pallets (313), the forks (107) and the mast (106) need to navigate around the floor of warehouse (311), ramp (312), and the floor of the trailer (315). The collision-free inserting trajectory of the forks and the mast may be generated using an automation software, optimization method, or a machine learning model. The automation software may be any software that minimizes the need for human input. The automation software may be designed to turn repeatable routine tasks into a series of automated actions. The optimization and machine learning models that may be used separately or in combination are, at least, A* planning, Nonlinear Least-Squares method, Interior point method. In some embodiments, a combination of different optimization and machine learning models may be used.

Further, FIG. 7 shows that the forks (107) may need to be configured to be able to enter the tail-adjacent pallet's pockets in order to lift the tail-adjacent pallet (313). When the forks (107) are not configured properly, the result may be that the forks (107) damage the transported loads, the trailer bed (315) or the forks may be damaged themselves.

The difficulty in obtaining accurate measurements of the trailer bed tilt, as well as, appropriately modeling the transition behavior of the robot from the ramp to the trailer bed, has motivated an approach that optimizes the lift and tilt position of the forks to target the center of the pallet pockets along the vertical axis. As shown in FIG. 4B, in S415, the optimization or machine learning based mast trajectory planning method generates optimal fork trajectories with respect to the determined fixed ramp geometry obtained in S411 and environment variables such as trailer bed tilt, ramp-trailer-bed transition obtained in S412 and integrated with the fixed geometry in S413. Additionally, a distance between the forks and a surface (e.g., warehouse floor, ramp, trailer floor, etc.) may be measured using sensors. The distance between the forks and the surface may be adjusted to prevent collision between the forks and the surface. As shown in FIG. 7, the generated trajectories ensure that the forks do not collide with any of the objects in its vicinity by adjusting the fork height and tilt as the robot transitions from the warehouse floor to the trailer to extract a tail pallet.

In one or more embodiments, in S415 the trajectory planning method generates fork trajectories that ensure that the forks, as much as possible, stay centered within the pallet pockets, obtained in S414, while trying to insert the forks into the pallet. The lift and tilt required to accomplish this is determined by applying the kinematic model of the robot combined with the known model of the ramp and the anticipated pitch of the robot induced by ramp traversal.

As shown in FIG. 4C, after detecting pallets and pallet pockets in Step S421, the forklift (100) adjusts mast lift and tilt to center forks at pallet pockets in Step S422. Further, in Step S423, the forklift drives into a trailer to pick up the pallet. As shows in Step S424 and Step S425, during the process of driving into a trailer and picking up the pallets the forklift (100) continuously detects current vehicle tilt and pallet pocket position, and adjusts mast lift and tilt to keep the forks centered to the pallet's pockets, in an iterative process.

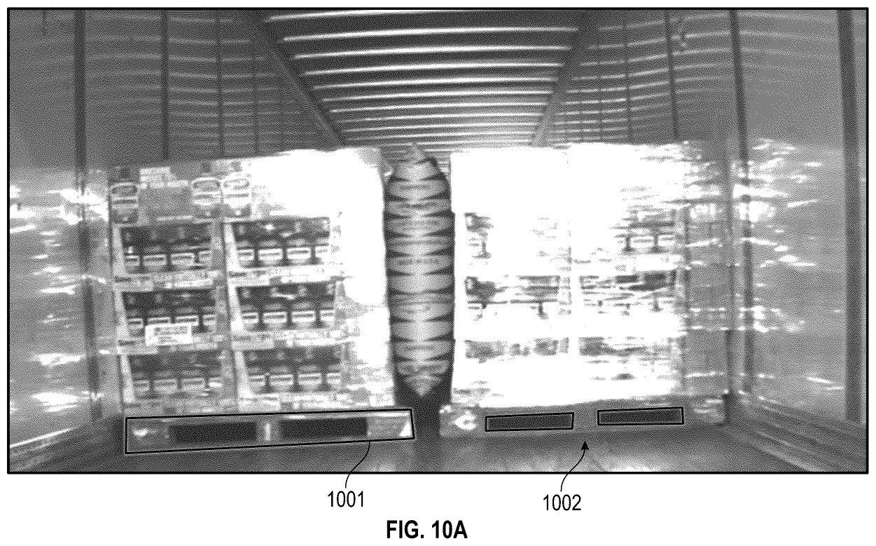

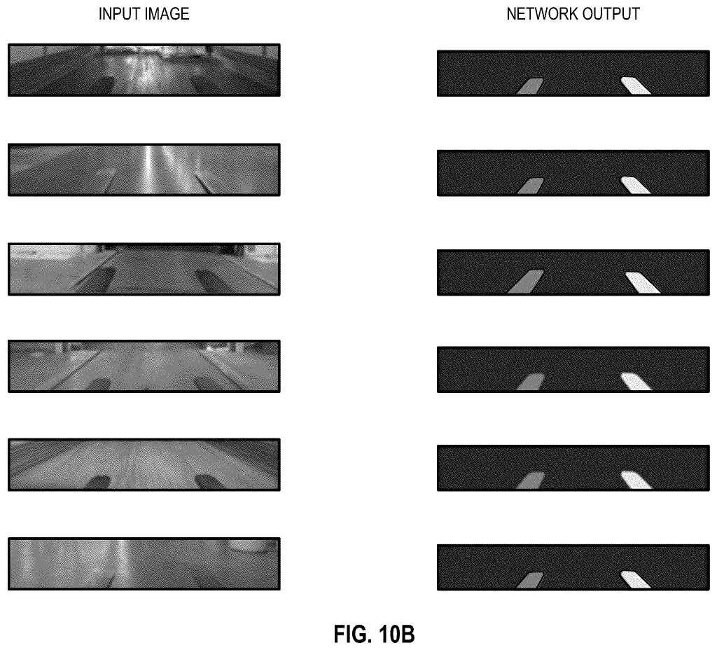

In S403 after reaching the pallet's pockets, the vehicle needs to adjust the configuration of the forks to fit inside of the pallet's pockets. As shown in FIGS. 10A and 10B, the machine learning model recognizes pallets (1001), pallet face-side pockets (1002), and a left and a right fork. A real-time position of the fork (107) and the pallet face-side pockets (1002) are continuously compared to ensure an appropriate lifting position. The forks (107) may be configured to move up and down, left and right, as well as to be tilted at an angle.

Further, FIG. 11 shows a model of the trajectory of the forks of the autonomous forklift when using the camera and sensors in accordance with one or more embodiments. The rate of tilt of the forks (1103) is represented with the dotted line. Specifically, when the vehicle is moving from the warehouse floor (311) to the ramp (312) the forks are tilted up (1103) to prepare for the insertion. The forks keep getting adjusted by being tilted up (1104) as the forklift steps on a ramp lip (1101) which is in contact with the truck bed (315) at a ramp touch point (1102). During the insertion, the forks are being tilted down (1105) as a response to the pallet's pockets position. Finally, when the configuration of the forks is determined, the tilt of the forks (1106) remains the same.

In one or more embodiments, the configuration of forks may be determined using a machine learning model, based on the obtained data. Specifically, when the data is obtained by sensors or cameras, the autonomy computer (210) uses a trained machine learning model to analyze the obtained data to recognize the shapes in the forklift's (100) navigational environment. Initially, the autonomy computer (210) uses the obtained images and the machine learning model to determine, at least, a length of a ramp (312), a height of a trailer floor bedding, and a size of pallet's pockets. Further, the sensors may be used to determine angle between the ramp (312) and the warehouse floor (311). The output of a machine learning model is a configuration of the forks, including the height of the forks and the tilt of the forks.

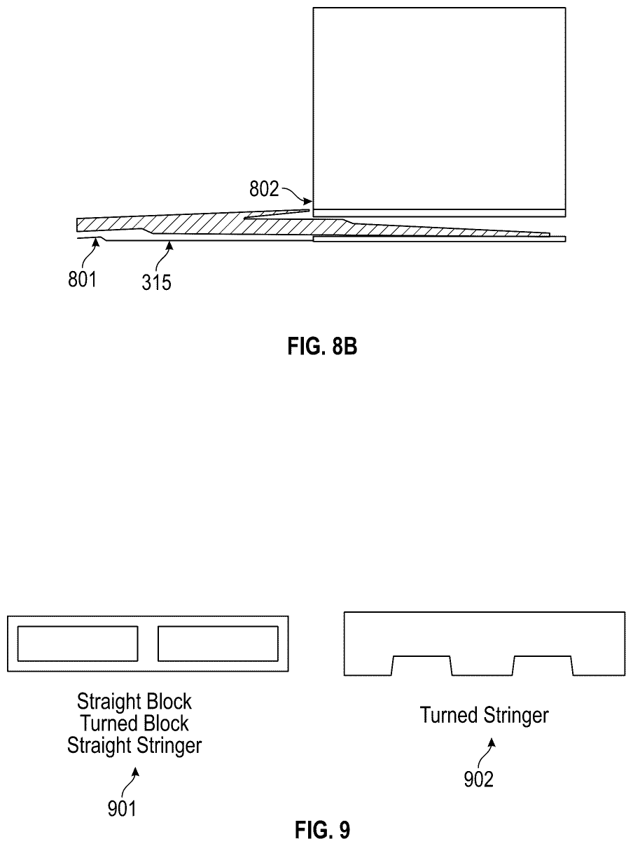

In some embodiments, such approach yields a policy that may robustly pick pallets even in the presence of uncertainty in the levelness of the trailer or ramp. Specifically, FIG. 8A shows an example in which optimizing the mast control with a cost function, that targets the center of the pallet pockets, yields a fork motion behavior that is robust to error in these angles within the range of −2 and +2 degrees. Specifically, the effective tilt angle of a non-flat trailer bed is greatest at the point where the drive wheels of the robot transition from the ramp to the truck. In this example, the distance between the center of the wheels and the fork tips is 1.2 m. The height of the pockets of most pallets, besides turned stringers, is 0.08 m. Hence, the center of the pocket is located at a distance of 0.04 m from the top and bottom slats of the pallets. The trigonometry may be applied to solve for the max trailer bed tilt for which targeting the center of the pallet pockets would guarantee fork insertion. As shown in FIG. 8A, the determined trailer bed tilt would be +/−1.9 degrees.

In one or more embodiments, the optimization approach has the capacity of the mast rejection planner to specify unique behaviors besides generic obstacle avoidance. In some embodiments, the ramp lip chamfer causes the height of the forks to drop suddenly, as the wheels of the robot transition from the ramp to the trailer bed. While the policy accounts for this height drop as shown in FIG. 8B, the mast rejection planner may further optimize for smoother fork positions such that the sudden drop in fork height at the transition point is minimized by obtaining smoother fork trajectories. Specifically, FIG. 8B shows a change of fork positions at transition point between the ramp and the trailed bed (801) where the height of forks drops as the wheels of the robot transition from the ramp to the trailer area (802).

FIG. 9 shows a difference between pallet pocket shapes between, at least, straight block pallets, turned block pallets, and straight stringer pallets (901) and, at least, turned stringer pallets (902). In some embodiments, the mast trajectory planner may require additional modifications to be used to generate fork trajectories for turned stringer pallets. For example, such modifications may permit the bottom scraping of the forks on the ramp, as the robot approaches the pallet. This may be possible because, unlike the other types of pallets, turned stringer pallets have no bottom slats, as shown in FIG. 9.

Additionally, using a sensor-based pallet pocket detection system may enable the forklift to detect the location of the pallet and its pockets and guide the policy of the optimization-based mast planner. Such sensors, including but not limited to, vision or depth sensing cameras are used to detect how high the pallet and its pockets are from the trailer bed. The superposition of this detection mechanism and optimization-based mast planning provides a significantly robust tail pallet picking scheme that is resilient to variations in trailer bed angles, as well as the robust to difficult-to-model environment variables such as ramp deflection, ramp-to-trailer-bed transition, etc.

Alternatively, in one or more embodiments, the configuration of the forks may be obtained using a visual feedback control. This method involves using a continuous stream of images, obtained by one or more on-board depth sensing cameras to guide the forks to perform a lifting operation. Specifically, with an on-board depth sensing camera, the vehicle may continuously detect the pockets of the pallet. Based on the detection the vehicle may estimate the pose of the pockets relative to the robot.

With variation in the environment, such as changing ramp angles, the robot may use its camera detection values to adjust the mast control policy to ensure proper fork insertion into the pallet pockets as the forklift moves across the ramp. This visual servoing feedback approach is an observation based method and may not use the ramp geometry. The visual servoing feedback approach may also be used in tandem with the feed forward trajectory planning method to account for any unexpected variations observed while following a nominal mast trajectory plan.

Turning back to FIG. 4A, in Step S404, after determining a configuration of the forks (107), the forks are guided into the pallet's pockets. When the forks (107) are successfully configured, the forks (107) are inserted into the pallet's pockets without damaging the load, the pallets, the trailer bedding, or the forks themselves.

In Step S405, after correctly inserting the forks, the vehicle is able to lift the pallets and to start the unloading process. The collision-free extracting trajectory of the forks and the mast may be generated using an automation software or a machine learning model. Specifically, the configuration of the forks for the extracting trajectory may be determined based on the data obtained by the sensors, the fixed geometry of the ramp, and a distance between the forks and the surface. Additionally, the extracting trajectory determination is also based on the size of the pallet and the size of the pallet pockets.

FIG. 4B, after Step S416 in which the trajectory is executed and the forks (107) are inserted in the pallet pockets (1002), in Step S417, a collision-free trajectory for extraction is determined. Finally, in Step S418, a pallet is extracted from the trailer and delivered to a designated location.

In one or more embodiments, the forklift may be configured to avoid potential obstacles encountered while picking up the pallets. While driving on a ramp requires planning in the vertical plane (i.e., mast planning for lift and tilt), avoiding obstacles may involve planning in the horizontal plane (mobile base planning).

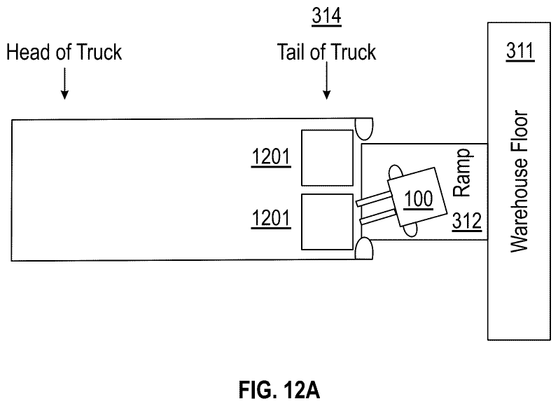

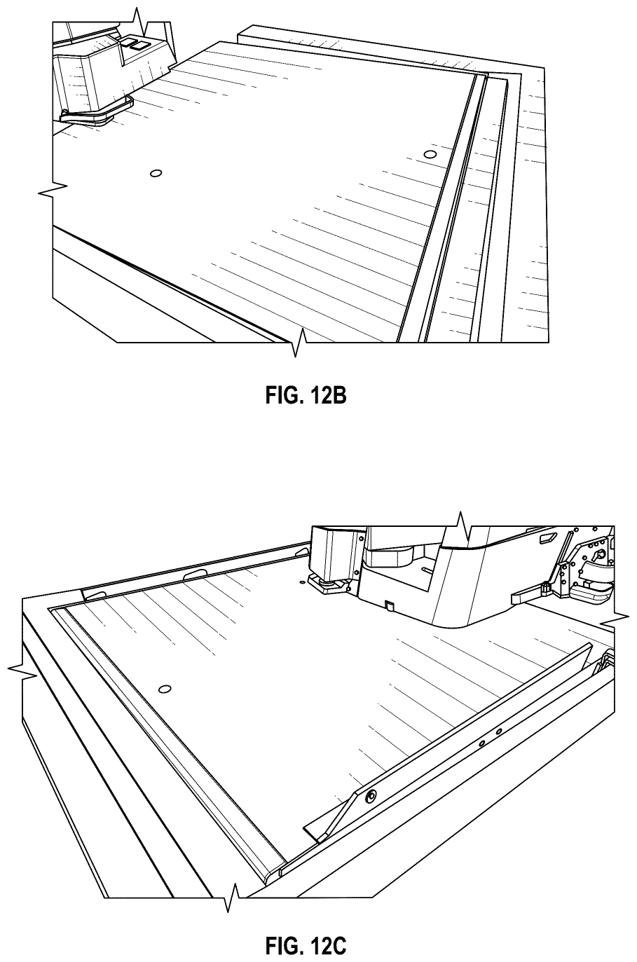

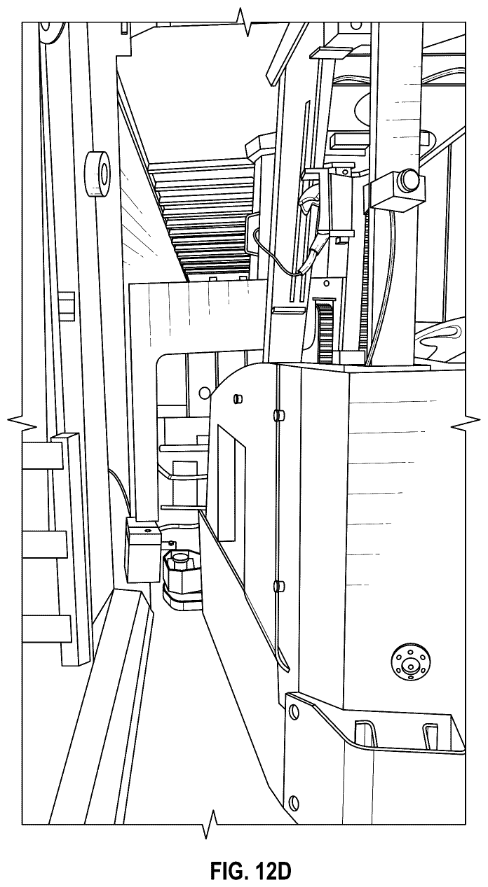

Specifically, when pallets are lodged at the corners of the very tail of the trailer, as shown in FIG. 12A, they can be difficult to extract from the trailer due to various reasons including, at least, ramp walls or protruding weather guards. The forklift (100) has two protruding lidar guards that may make extraction of corner tail pallets (1201) difficult when the ramp walls are present. The ramp walls may appear either due to ramps being depressed, as shown in FIG. 12B or due to the presence of welded metal walls, as shown in FIG. 12C. In the case where ramp walls appear from a sunken or declined ramp, it may be determined whether the warehouse walls are high enough to cause collision with the robot's lidar guards by combining the obtained geometric information about the ramp (e.g., ramp length) with the sensor measurement of the ramp tilt. Additionally, in some embodiments, a limited collision may be tolerated to enable smoother operation of the forklift. Specifically, the operator or the system may determine that certain collisions do not affect the safety of the load or the procedure and such limited collisions may be tolerated.

In one or more embodiments, the obstacle presented by the ramp walls may be mitigated by a diagonal approach method. Specifically, while a direct approach may be enforced for non-tail pallets, for non-tail pallets, in an attempt to avoid collisions between the body of our robot and ramp walls, a diagonal approach may be used. A difference between a direct approach and a diagonal approach is that while in a direct approach the forks must be under right angle to the pallet pockets, in a diagonal approach the angle may vary, and the forks may enter the pallet pockets diagonally.

In some embodiments, the diagonal approach method may not be enough to successfully extract a corner tail pallet. Therefore, a two-touch picking method may be used. The two-touch method allows the robot to shallow-pick a pallet. Specifically, the two-touch method allows pulling a pallet with only partially inserted forks to slightly moving the pallet to a more convenient location, back out from the pallet, and then attempt a full insertion to fully extract the pallet from the trailer. One of such convenient locations that the forklift may move the pallet to is the center of the truck. As shown in FIG. 12, there may be space between the target pallet and the neighboring pallet, in which case, the robot may side-shift the target pallet towards the center of the truck. While the side-shift travel distance may be small (e.g., only a few inches), it may make a significant difference in whether or not a corner tail pallet is successfully extracted. An additional extension of this approach may be to insert a single fork only during the initial touch for extremely offset pallets, then re-insert with both forks to pick.

In one or more embodiments, the protruding weather guards may be an obstacle during the pallet extraction process. Specifically, as shown in FIG. 12D, some of the docks where the forklifts are deployed, may have significantly pronounced weather guards that encroach into the pallet region where corner pallets are situated. These weather guards trip up the forklift safety systems, causing the forklift to stop. To deal with this, the system may determine regions where we detect or expect weather guards to be situated, including whether or not they are deformable and may be pushed aside by the forklift or the pallet. This information is then fed into the forklifts planning scheme, allowing the forklift to avoid areas where we expect weather guards to be.

Embodiments disclosed herein may be implemented on any suitable computing device, such as the computer system shown in FIG. 13. Specifically, FIG. 13 is a block diagram of a computer system (1300) used to provide computational functionalities associated with described algorithms, methods, functions, processes, flows, and procedures as described in the instant disclosure, according to an implementation. The illustrated computer (1300) is intended to encompass any computing device such as a high-performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1300) may include a computer that includes an input device, such as a keypad, keyboard, touch screen, or other device that can accept user information, and an output device that conveys information associated with the operation of the computer (1300), including digital data, visual, or audio information (or a combination of information), or a GUI.

The computer (1300) can serve in a role as a client, network component, a server, a database or other persistency, or any other component (or a combination of roles) of a computer system for performing the subject matter described in the instant disclosure. The illustrated computer (1300) is communicably coupled with a network (1310). In some implementations, one or more components of the computer (1300) may be configured to operate within environments, including cloud-computing-based, local, global, or other environment (or a combination of environments).

At a high level, the computer (1300) is an electronic computing device operable to receive, transmit, process, store, or manage data and information associated with the described subject matter. According to some implementations, the computer (1300) may also include or be communicably coupled with an application server, e-mail server, web server, caching server, streaming data server, business intelligence (BI) server, or other server (or a combination of servers).

The computer (1300) can receive requests over network (1310) from a client application (for example, executing on another computer (1300) and responding to the received requests by processing the said requests in an appropriate software application. In addition, requests may also be sent to the computer (1300) from internal users (for example, from a command console or by other appropriate access method), external or third-parties, other automated applications, as well as any other appropriate entities, individuals, systems, or computers.

Each of the components of the computer (1300) can communicate using a system bus (1370). In some implementations, any or all of the components of the computer (1300), both hardware or software (or a combination of hardware and software), may interface with each other or the interface (1320) (or a combination of both) over the system bus (1370) using an application programming interface (API) (1350) or a service layer (1360) (or a combination of the API (1350) and service layer (1360). The API (1350) may include specifications for routines, data structures, and object classes. The API (1350) may be either computer-language independent or dependent and refer to a complete interface, a single function, or even a set of APIs. The service layer (1360) provides software services to the computer (1300) or other components (whether or not illustrated) that are communicably coupled to the computer (1300). The functionality of the computer (1300) may be accessible for all service consumers using this service layer. Software services, such as those provided by the service layer (1360), provide reusable, defined business functionalities through a defined interface. For example, the interface may be software written in JAVA, C++, or other suitable language providing data in extensible markup language (XML) format or another suitable format. While illustrated as an integrated component of the computer (1300), alternative implementations may illustrate the API (1350) or the service layer (1360) as stand-alone components in relation to other components of the computer (1300) or other components (whether or not illustrated) that are communicably coupled to the computer (1300). Moreover, any or all parts of the API (1350) or the service layer (1360) may be implemented as child or sub-modules of another software module, enterprise application, or hardware module without departing from the scope of this disclosure.

The computer (1300) includes an interface (1320). Although illustrated as a single interface (1320) in FIG. 13, two or more interfaces (1320) may be used according to particular needs, desires, or particular implementations of the computer (1300). The interface (1320) is used by the computer (1300) for communicating with other systems in a distributed environment that are connected to the network (1310). Generally, the interface (1320 includes logic encoded in software or hardware (or a combination of software and hardware) and operable to communicate with the network (1310). More specifically, the interface (1320) may include software supporting one or more communication protocols associated with communications such that the network (1310) or interface's hardware is operable to communicate physical signals within and outside of the illustrated computer (1300).

The computer (1300) includes at least one computer processor (1330). Although illustrated as a single computer processor (1330) in FIG. 13, two or more processors may be used according to particular needs, desires, or particular implementations of the computer (1300). Generally, the computer processor (1330) executes instructions and manipulates data to perform the operations of the computer (1300) and any algorithms, methods, functions, processes, flows, and procedures as described in the instant disclosure.

The computer (1300) also includes a memory (1380) that holds data for the computer (1300) or other components (or a combination of both) that can be connected to the network (1310). For example, memory (1380) can be a database storing data consistent with this disclosure. Although illustrated as a single memory (1380) in FIG. 13, two or more memories may be used according to particular needs, desires, or particular implementations of the computer (1300) and the described functionality. While memory (1380) is illustrated as an integral component of the computer (1300), in alternative implementations, memory (1380) can be external to the computer (1300).

The application (1340) is an algorithmic software engine providing functionality according to particular needs, desires, or particular implementations of the computer (1300), particularly with respect to functionality described in this disclosure. For example, application (1340) can serve as one or more components, modules, applications, etc. Further, although illustrated as a single application (1340), the application (1340) may be implemented as multiple applications (1340) on the computer (1300). In addition, although illustrated as integral to the computer (1300), in alternative implementations, the application (1340) can be external to the computer (1300).

There may be any number of computers (1300) associated with, or external to, a computer system containing computer (1300), each computer (1300) communicating over network (1310). Further, the term “client,” “user,” and other appropriate terminology may be used interchangeably as appropriate without departing from the scope of this disclosure. Moreover, this disclosure contemplates that many users may use one computer (1300), or that one user may use multiple computers (1300).

In some embodiments, the computer (1300) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AlaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method for a tail-adjacent pallet picking, comprising:
obtaining a fixed geometry of a ramp, the ramp operatively connecting a trailer floor to a warehouse floor associated with operation of an autonomous forklift;
obtaining, using a computer processor and a plurality of sensors, data comprising a location of the tail-adjacent pallet and a location of pallet pockets of the tail-adjacent pallet;
determining, using the computer processor and based on the fixed geometry of the ramp and the obtained data, an inserting trajectory of forks;
determining, using the computer processor, a configuration of the forks of the autonomous forklift based on the inserting trajectory;
inserting the forks of the autonomous forklift into the pallet pockets of the tail-adjacent pallet, based on the determined configuration of the forks; and
extracting the tail-adjacent pallet based on the determined configuration of the forks of the autonomous forklift.

2. The method of claim 1, wherein determining the inserting trajectory of the forks of the autonomous forklift comprises:
detecting, using the computer processor and based on the fixed geometry of the ramp and the obtained data, a tilt of the autonomous forklift; and
adjusting, using the computer processor and based on the fixed geometry of the ramp, the obtained data, and the detected tilt of the autonomous forklift, a lift and a tilt of the forks and a mast to avoid colliding with a surface, the surface including the warehouse floor, the ramp, and the trailer floor.

3. The method of claim 1, wherein determining the configuration of the forks of the autonomous forklift comprises:
detecting, using the computer processor and the plurality of sensors, the location of the tail-adjacent pallet and the location of pallet pockets of the tail-adjacent pallet; and
adjusting, using the computer processor and based on the obtained data, a plurality of degrees of freedom the forks of the autonomous forklift to enable collision-free trajectory for insertion of the forks of the autonomous forklift into the pallet pockets, the plurality of degrees of freedom including a lift, a tilt, a side shift, and a spread of the forks.

4. The method of claim 1, wherein the fixed geometry of the ramp comprises a length of the ramp, a width of the ramp, an angle between the ramp and a ramp lip, steepness of the ramp lip, and a shape of the ramp lip.

5. The method of claim 4, wherein the fixed geometry of the ramp is obtained, using the computer processor and a machine learning model, by generating a full surface contour model based on a plurality of sensor measurements.

6. The method of claim 4, wherein the fixed geometry of the ramp is obtained using manual measurements.

7. The method of claim 1, wherein the obtained data may further comprise a variable geometry of the ramp, wherein the variable geometry of the ramp is selected from the group consisting of an angle of the ramp, an angle of a trailer bed, a height of the trailer bed, and combinations thereof.

8. The method of claim 7, wherein the variable geometry of the ramp is obtained using the plurality of sensors mounted on the autonomous forklift.

9. A method for a tail-adjacent pallet picking, comprising:
obtaining, using a computer processor and a plurality of sensors, data comprising a location of a ramp, a location of the tail-adjacent pallet, and a location of pallet pockets of the tail-adjacent pallet, wherein the ramp operatively connects a trailer floor to a warehouse floor associated with operation of an autonomous forklift;
determining, using the computer processor and based on the plurality of sensors, a distance between forks and the ramp;
adjusting, using the computer processor and a machine learning model, a configuration of the forks of the autonomous forklift;
inserting the forks of the autonomous forklift into the pallet pockets of the tail-adjacent pallet, based on the determined configuration of the forks; and
extracting the tail-adjacent pallet based on the determined configuration of the forks of the autonomous forklift.

10. The method of claim 9, wherein determining the configuration of the forks of the autonomous forklift comprises:
detecting, using the computer processor and the plurality of sensors, the location of the tail-adjacent pallet and the location of pallet pockets of the tail-adjacent pallet; and
adjusting, using the computer processor and based on the obtained data, a plurality of degrees of freedom the forks of the autonomous forklift to enable collision-free trajectory for insertion of the forks of the autonomous forklift into the pallet pockets, the plurality of degrees of freedom including a lift, a tilt, a side shift, and a spread of the forks.

11. The method of claim 9, wherein the data is obtained using the plurality of sensors and a plurality of cameras mounted on the autonomous forklift.

12. The method of claim 11, wherein the plurality of sensors mounted on the autonomous forklift determines a surface contour of the ramp, the location of the pallet, and the location of pallet pockets.

13. The method of claim 9, wherein a full surface contour model is generated, using the computer processor, based on a plurality of sensor measurements, and
wherein the configuration of the forks is determined based on the full surface contour model.

14. A system comprising:
an autonomous forklift comprising: a plurality of sensors mounted on the autonomous forklift and forks configured to be inserted into pockets of a tail-adjacent pallet,
the plurality of sensors being configured to obtain data comprising a geometry of a ramp, a location of the tail-adjacent pallet, and a location of pallet pockets in the tail-adjacent pallet;
the ramp operatively connecting a trailer floor to a warehouse floor associated with operation of the autonomous forklift; and
the tail-adjacent pallet being located on the trailer floor, wherein the tail-adjacent pallet is configured to be picked up and moved by the autonomous forklift using an inserting trajectory of the forks of the autonomous forklift,
wherein a configuration of the forks of the autonomous forklift to pick up the tail-adjacent pallet is based on the geometry of the ramp and the location of the tail-adjacent pallet, and the location of pallet pockets in the tail-adjacent pallet.

15. The system of claim 14, wherein the plurality of sensors include an Inertial Measurement Unit (“IMU”), a Light Detection and Ranging (“LiDAR,”) a plurality of encoders, and a camera system.

16. The system of claim 14, wherein determining the configuration of the forks of the autonomous forklift comprises:
detecting, using a computer processor and the plurality of sensors, the location of the tail-adjacent pallet and the location of pallet pockets of the tail-adjacent pallet; and
adjusting, using the computer processor and based on the obtained data, a plurality of degrees of freedom the forks of the autonomous forklift to enable collision-free trajectory for insertion of the forks of the autonomous forklift into the pallet pockets, the plurality of degrees of freedom including a lift, a tilt, a side shift, and a spread of the forks.

17. The system of claim 14, wherein the geometry of the ramp comprises a fixed geometry of the ramp and a variable geometry of the ramp,
wherein the fixed geometry of the ramp includes a length of the ramp, a width of the ramp, an angle between the ramp and a ramp lip, steepness of the ramp lip, and a shape of the ramp lip, and
wherein the variable geometry of the ramp includes an angle of the ramp.

18. The system of claim 17, wherein the fixed geometry of the ramp is obtained, using a computer processor and a machine learning model, by generating a full surface contour model based on a plurality of sensor measurements.

19. The system of claim 17, wherein the fixed geometry of the ramp is obtained using manual measurements.

20. The system of claim 17, wherein the variable geometry of the ramp is obtained using the plurality of sensors mounted on the autonomous forklift.
